(19) United States
(12) Patent Application Publication
(10) Pub. No.: US 2021/0311345 A1
(43) Pub. Date: Oct. 7, 2021

(54) CHOLESTERIC LIQUID CRYSTAL DISPLAY DEVICE AND FABRICATION METHOD THEREOF

(71) Applicant: Sole Optoelectronics Co., Ltd., New Taipei City (TW)

(72) Inventors: Ren-Lu Chen, Taipei City (TW); Tzu-Chieh Lai, Hsinchu County (TW); Shui-Chih Lien, Hsinchu City (TW)

(21) Appl. No.: 16/984,162

(22) Filed: Aug. 4, 2020

(30) Foreign Application Priority Data
Apr. 1, 2020 (TW) 109111215

(51) Int. Cl. G02F 1/137; G02F 1/1335; G02F 1/1339; G02F 1/1368

(52) U.S. Cl. CPC G02F 1/13718; G02F 1/133512; G02F 2201/08; G02F 1/1368; G02F 1/1339

(57) ABSTRACT

The invention provides a cholesteric liquid crystal display device, which includes a first substrate, a second substrate, a cholesteric liquid crystal layer, a switch, and a black light absorption layer. The first substrate includes a first surface and a second surface opposite to the first surface. The switch is disposed on the first surface of the first substrate. The second substrate is disposed opposite to the first substrate. The cholesteric liquid crystal layer is disposed between the first substrate and the second substrate. The black light absorption layer is disposed between the switch and the cholesteric liquid crystal layer, or on the second surface of the first substrate.

### BACKGROUND OF THE INVENTION

### 1. Field of the Invention

The present invention relates to a liquid crystal display and a fabrication method thereof, in particular to an active matrix addressed bistable reflective liquid crystal display including a black light absorption layer and a related fabrication method thereof.

### 2. Description of the Prior Art

The reflective liquid crystal display does not need a backlight module as a light source, and therefore has the advantages of light weight and low power consumption. At present, reflective LCD displays are used in numerous electronic products, such as writing tablets in children's education market, electronic papers, tablet PCs, laptop computers, and Internet of Things for hypermarkets. Among them, cholesteric liquid crystal has the characteristics of selectively reflecting light in a certain wavelength range and showing bistable state without applying voltage, thus it is suitable for reflective liquid crystal displays and can further achieve the effect of power saving.

When the cholesteric liquid crystal display is in a dark state, a portion of the lights will penetrate the cholesteric liquid crystal or being scattered within the display. However, these lights may be reflected by the metal elements inside the display, which causes the user to perceive the weak lights and reduces the reflection contrast of the cholesteric liquid crystal display, thereby negatively affecting the display quality.

### SUMMARY OF THE INVENTION

The present invention provides a cholesteric liquid crystal display and a fabricating method thereof, which improves the reflection contrast and optimizes the display quality of the cholesteric liquid crystal display through a black light absorption layer.

According to one embodiment of the present invention, a cholesteric liquid crystal display device includes a first substrate, a second substrate, a cholesteric liquid crystal layer, a switch and a black light absorption layer. The first substrate includes a first surface and a second surface opposite to the first surface. The switch is disposed on the first surface of the first substrate. The second substrate is disposed opposite to the first substrate. The cholesteric liquid crystal layer is disposed between the first substrate and the second substrate. The black light absorption layer is disposed between the switch and the cholesteric liquid crystal layer, or is disposed on the second surface of the first substrate.

According to one embodiment of the present invention, a method for fabricating a cholesteric liquid crystal display device includes the following steps: providing a first substrate, wherein the first substrate includes a first surface and a second surface opposite to the first surface; forming a switch on the first surface of the first substrate; forming a black light absorption layer on the first substrate; assembling the first substrate with a second substrate, and forming a cholesteric liquid crystal layer between the first substrate and the second substrate, wherein the black light absorption layer is disposed between the switch and the cholesteric liquid crystal layer, or is disposed on the second surface of the first substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 8 are schematic diagrams of a method for fabricating a cholesteric liquid crystal display according to a first embodiment of the present invention.

FIG. 9 to FIG. 10 are schematic diagrams of a method for fabricating a cholesteric liquid crystal display according to a second embodiment of the present invention.

FIG. 11 to FIG. 12 are schematic diagrams of a method for fabricating a cholesteric liquid crystal display according to a third embodiment of the present invention.

FIG. 13 is a schematic top view of a spacer and a surrounding transparent conductive layer according to the third embodiment of the present invention.

FIG. 14 to FIG. 17 are schematic diagrams of a method for fabricating a cholesteric liquid crystal display according to a fourth embodiment of the present invention.

FIG. 18 to FIG. 20 are schematic diagrams of a method for fabricating a cholesteric liquid crystal display according to a fifth embodiment of the present invention.

FIG. 21 is a flowchart of steps of a method for fabricating a cholesteric liquid crystal display of the present invention.

### DETAILED DESCRIPTION

Those skilled in the art can understand the invention by referring to the following detailed description and meanwhile combining the drawings. It should be noted that in order to make it easy for the reader to understand and to make the drawings concise, the drawings of the present invention depict merely a portion of the cholesteric liquid crystal display and the specific elements in the drawings are not drawn to actual scale. Furthermore, the number and size of each element in the drawing are only for illustration and are not intended to limit the scope of the invention.

It should be understood that when an element or a film layer is referred to as being “on” or “connected to” the other element or film layer, it can be directly on the other element or film layer or directly connected to the other element or film layer, or an intervening element or film layer can existed between the two. In contrast, when an element is referred to as being “directly on” or “directly connected to” the other element or film layer, there is no intervening element or film layer existed between the two.

It should be noted that the technical features in the following various embodiments can be replaced, rearranged, and mixed to accomplish other embodiments without departing from the spirit of the present invention.

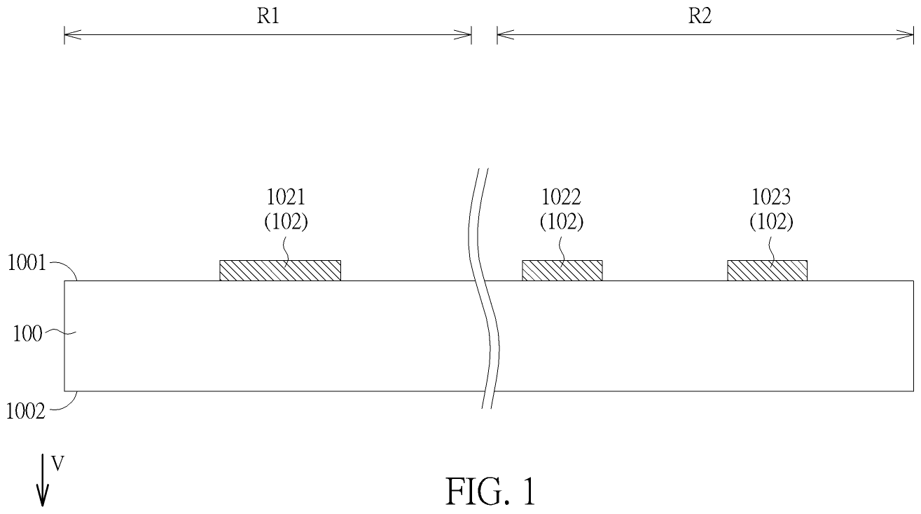

Referring to FIG. 1 to FIG. 8, those are schematic diagrams of a method for fabricating a cholesteric liquid crystal display according to a first embodiment of the present invention. As shown in FIG. 1, a first substrate 100 is provided at first, and the first substrate 100 may include a first surface 1001 and a second surface 1002 opposite to the first surface 1001. The first substrate 100 of the present embodiment may be, for example, a rigid substrate (such as a glass substrate), but it is not limited thereto. The first substrate 100 may include, for example, a rigid substrate or a flexible substrate. The rigid substrate may include, for example, glass, quartz, ceramic, sapphire, other suitable materials, or a combination thereof, but it is not limited thereto. The flexible substrate may include, for example, a plastic substrate such as a polyimide (PI) substrate, a polycarbonate (PC) substrate, a polyethylene terephthalate (PET) substrate, other suitable substrates, or a combination thereof, but it is not limited thereto.

In addition, a display area R1 and a peripheral area R2 located on at least one side of the display area R1 may be defined in the first substrate 100. For example, when viewing the first surface 1001 of the first substrate 100 in a top view direction V, the peripheral area R2 may surround the display area R1, but it is not limited thereto.

Next, a switch is formed on the first surface 1001 of the first substrate 100. A method for fabricating the switch will be described in detail below. As shown in FIG. 1, a first conductive layer 102 is formed on the first surface 1001 of the first substrate 100. The first conductive layer 102 may be a metal layer, and may include a single-layer structure or a multi-layer structure, but it is not limited thereto. For example, the first conductive layer 102 in the present embodiment may include a multi-layer structure such as molybdenum/aluminum/molybdenum or titanium/aluminum/titanium, but it is not limited thereto. In FIG. 1, the first conductive layer 102 may include a conductive member 1021, a conductive member 1022, and a conductive member 1023. The conductive member 1021 may be, for example, disposed in the display area R1, and may serve as, for example, a gate of the switch, but it is not limited thereto. The conductive member 1022 and the conductive member 1023 may be, for example, disposed in the peripheral region R2, and may be used as components such as signal lines or bonding pads, but it is not limited thereto. The first conductive layer 102 may be, for example, a patterned conductive layer formed through a photolithography and etching process, but it is not limited thereto.

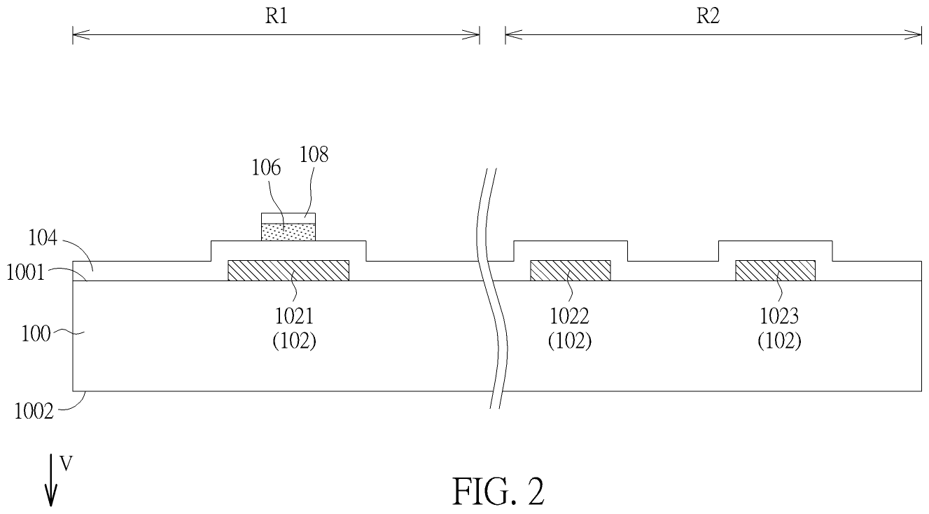

Next, as shown in FIG. 2, a gate insulating layer 104 is conformally formed on the first conductive layer 102. The gate insulating layer 104 may cover the first conductive layer 102 (such as the conductive members 1021, 1022, and 1023) and a portion of the first surface 1001. The gate insulating layer 104 may be formed on the first surface 1001 of the first substrate 100 completely, and the thickness of the gate insulating layer 104 may be several thousand angstroms, but it is not limited thereto. Then, as shown in FIG. 2, a semiconductor layer 106 is formed on the gate insulating layer 104, and the semiconductor layer 106 may be disposed on the conductive member 1021 (such as a gate). In the present embodiment, the material of the semiconductor layer 106 may be amorphous silicon, but it is not limited thereto. In other embodiments, the material of the semiconductor layer 106 may also include suitable semiconductor materials, such as low temperature polysilicon (LTPS), metal oxides (such as indium gallium zinc oxide (IGZO)). Next, as shown in FIG. 2, a doped layer 108 is formed on the semiconductor layer 106. The material of the doped layer 108 in the present embodiment may include doped amorphous silicon (such as n-type amorphous silicon), but it is not limited thereto. The semiconductor layer 106 and the doped layer 108 may be, for example, a patterned semiconductor layer and a patterned doped layer formed through photolithography and etching processes, but it is not limited thereto.

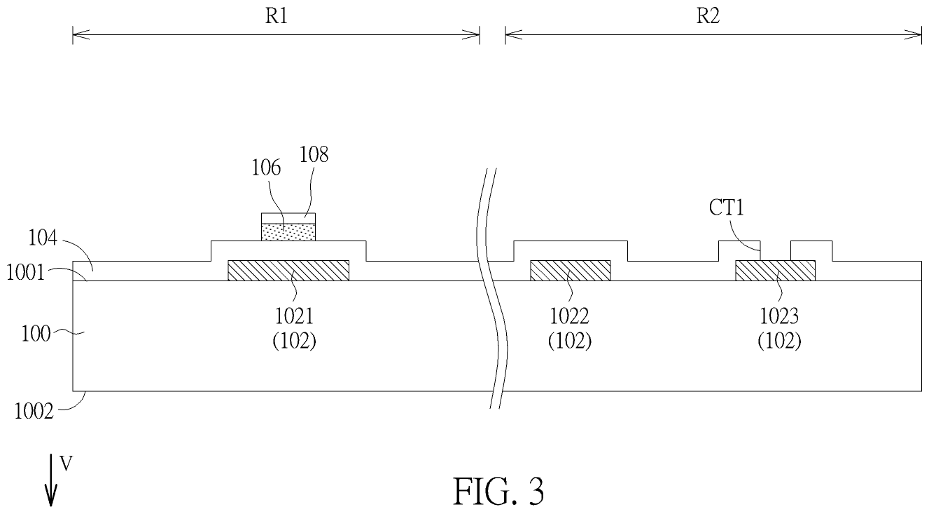

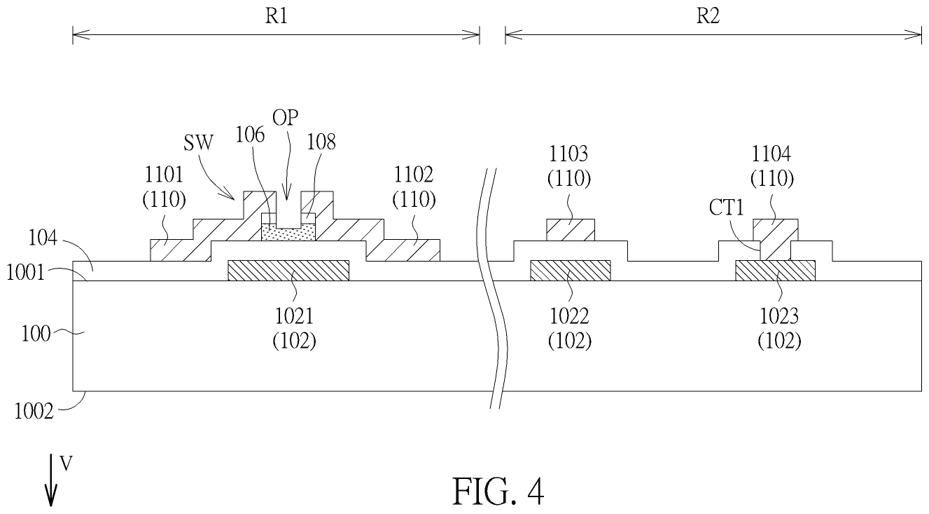

Next, as shown in FIG. 3, a contact hole CT1 is formed in the gate insulating layer 104. The contact hole CT1 can penetrate through the gate insulating layer 104 and expose a portion of the upper surface of the conductive member 1023, but it is not limited thereto. The contact hole CT1 may be formed through the photolithography and etching process, but it is not limited thereto. Next, as shown in FIG. 4, a second conductive layer 110 is formed on the gate insulating layer 104, the semiconductor layer 106 and the doped layer 108. The second conductive layer 110 may be a metal layer, and may include a single-layer structure or a multi-layer structure, but it is not limited thereto. For example, the second conductive layer 110 in the present embodiment may include a multi-layer structure such as molybdenum/aluminum/molybdenum or titanium/aluminum/titanium, but it is not limited thereto.

As shown in FIG. 4, the second conductive layer 110 may include a conductive member 1101, a conductive member 1102, a conductive member 1103, and a conductive member 1104. The conductive member 1101 and the conductive member 1102 may be, for example, disposed in the display area R1. The conductive member 1101 may serve as, for example, a source of the switch, and the conductive member 1102 may serve as, for example, a drain of the switch, but it is not limited thereto. The conductive member 1103 and the conductive member 1104 may be disposed, for example, in the peripheral region R2. The conductive member 1103 and the conductive member 1104 may be used as components such as signal lines or bonding pads, but it is not limited thereto. The second conductive layer 110 may be, for example, a patterned conductive layer formed through the photolithography and etching process, but it is not limited thereto.

As shown in FIG. 4, the conductive member 1101 (such as the source) may be in contact with a portion of the semiconductor layer 106 and a portion of the doped layer 108. The conductive member 1102 (such as the drain) may be in contact with the other part of the semiconductor layer 106 and the other part of the doped layer 108. The conductive member 1101 and the conductive member 1102 can be separated by an opening OP, and the opening OP can penetrate through the doped layer 108 and a portion of the semiconductor layer 106. In FIG. 4, the switch SW may be a bottom gate thin film transistor, wherein the switch SW may include a gate (such as the conductive member 1021), a source (such as the conductive member 1101), and a drain (such as the conductive member 1102), a semiconductor layer 106, a doped layer 108 and a portion of the gate insulating layer 104, but it is not limited thereto. In other embodiments, the switch SW may also be a top gate thin film transistor or other suitable type of transistor.

In FIG. 4, a portion of the conductive member 1104 may be filled in the contact hole CT1 and in contact with a portion of the upper surface of the conductive member 1023 to achieve the electrical connection. The conductive member 1104 and the conductive member 1023 may be, for example, a layer transfer structure. For example, the signal lines of different conductive layers can be electrically connected to each other through the layer transfer structure. Moreover, the conductive member 1103 may be disposed on the conductive member 1022, and a portion of the gate insulating layer 104 may be provided between the conductive member 1103 and the conductive member 1022, so that the conductive member 1103 and the conductive member 1022 can be electrically isolated.

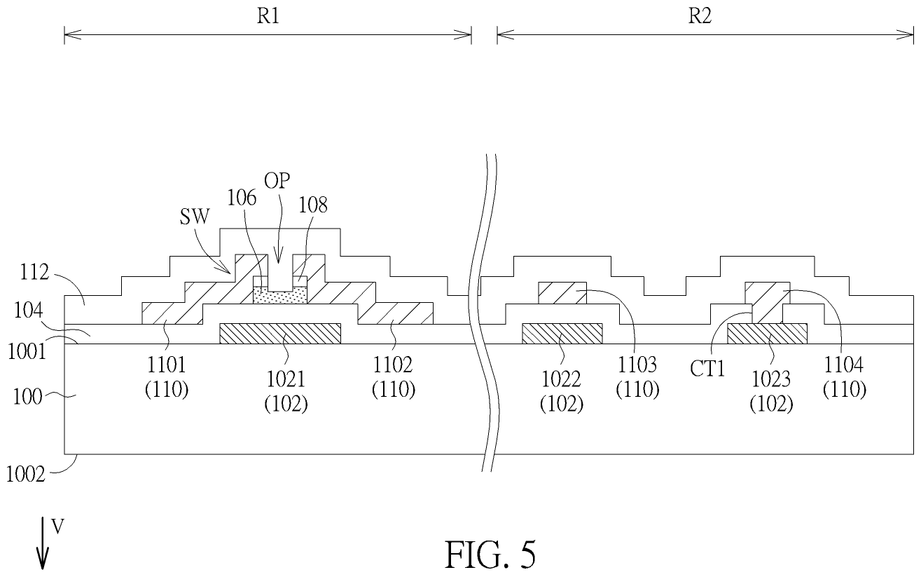

Next, as shown in FIG. 5, a first insulating layer 112 is formed on the switch SW. The first insulating layer 112 may be conformally formed on the switch SW, the conductive member 1103, the conductive member 1104, and a portion of the gate insulating layer 104, but it is not limited thereto. In other words, the first insulating layer 112 may cover the switch SW, the conductive member 1103, the conductive member 1104, and a portion of the gate insulating layer 104. For example, the thickness of the first insulating layer 112 in the present embodiment may be around 1000 angstroms, but it is not limited thereto.

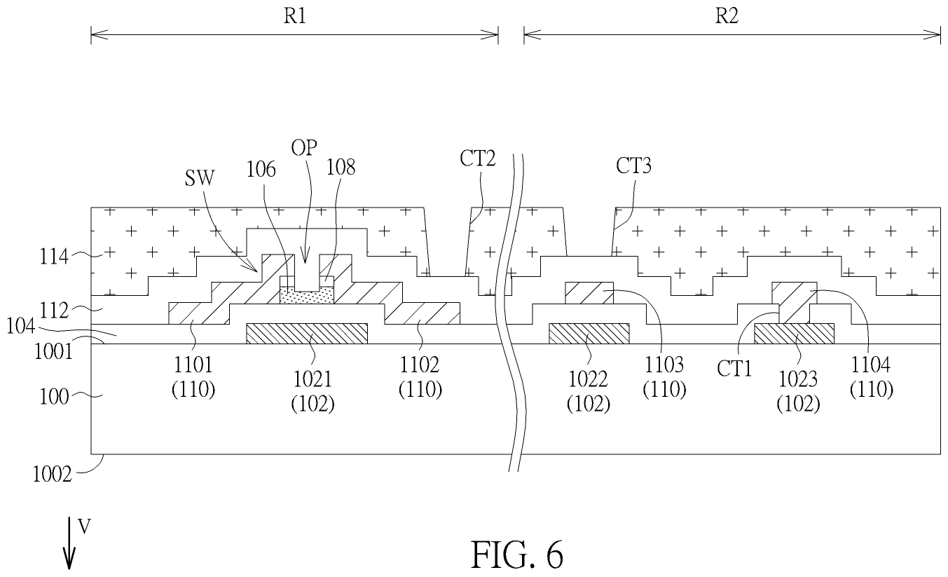

Next, as shown in FIG. 6, a black light absorption layer 114 is formed on the first insulating layer 112 so that the first insulating layer 112 is disposed between the switch SW and the black light absorption layer 114. The black light absorption layer 114 may include a black photoresist material, a black resin material, or other suitable light absorption materials, but it is not limited thereto. In the present invention, the thickness of the black light absorption layer 114 may range from about 0.5 micrometers (μm) to about 3 μm, but it is not limited thereto. For example, the thickness of the black light absorption layer 114 in this embodiment may be about 1 μm, but it is not limited thereto. In addition, the black light absorption layer 114 of this embodiment may provide a flat upper surface, but it is not limited thereto. Furthermore, the optical density of the black light absorption layer 114 of the present invention may be in a range from about 2 to about 6, but it is not limited thereto.

Next, as shown in FIG. 6, a contact hole CT2 and a contact hole CT3 can be formed in the black light absorption layer 114 through the photolithography and etching process. The contact hole CT2 can be disposed on the conductive member 1102 (such as the drain), and the contact hole CT2 can penetrate through the black light absorption layer 114 so as to expose a portion of the upper surface of the first insulating layer 112. The contact hole CT3 can be disposed on the conductive member 1103, and the contact hole CT3 can penetrate through the black light absorption layer 114 so as to expose another part of the upper surface of the first insulating layer 112.

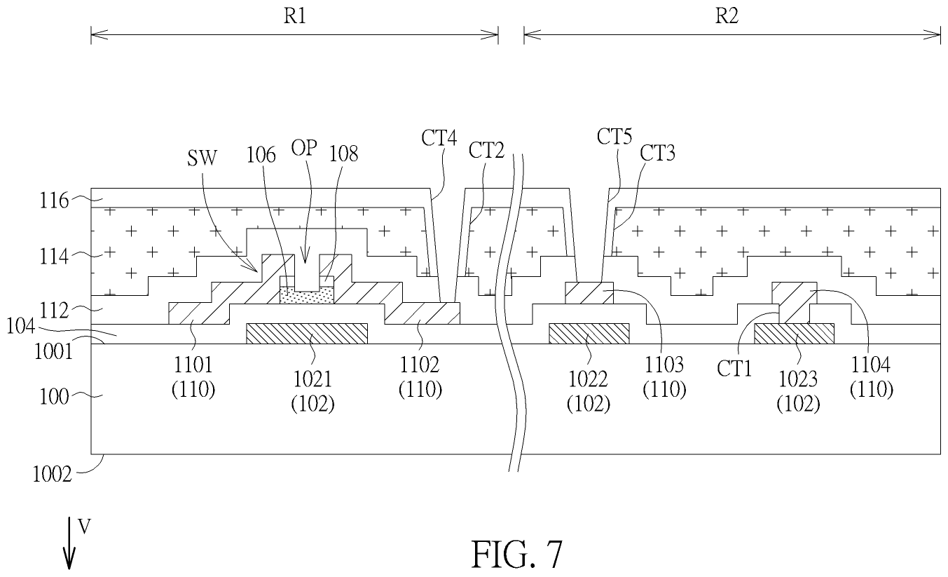

Then, as shown in FIG. 7, a second insulating layer 116 is formed on the black light absorption layer 114, and a portion of the second insulating layer 116 may be filled in the contact hole CT2 and the contact hole CT3. For example, the thickness of the second insulating layer 116 may range from about 0.2 μm to about 2.0 μm, but it is not limited thereto. In the present embodiment, the thickness of the second insulating layer 116 may be less or greater than the thickness of the black light absorption layer 114, but it is not limited thereto. For example, the second insulating layer 116 may be formed through a low temperature process. In some embodiments, the temperature for forming the second insulating layer 116 may be less than or equal to 300 degrees Celsius (° C.). In other embodiments, the temperature for forming the second insulating layer 116 may be less than or equal to 250° C. On the other hand, the materials of the gate insulating layer 104, the first insulating layer 112, and the second insulating layer 116 may include inorganic insulating materials such as silicon oxide, silicon nitride, or silicon oxynitride, but it is not limited thereto. The materials of the gate insulating layer 104, the first insulating layer 112 and the second insulating layer 116 may also include organic insulating materials or organic/inorganic composite insulating materials.

Next, as shown in FIG. 7, a contact hole CT4 and a contact hole CT5 may be formed through the photolithography and etching process. The position of the contact hole CT4 can correspond to the contact hole CT2, and the contact hole CT4 can penetrate through the second insulating layer 116 and the first insulating layer 112, so as to expose a portion of the upper surface of the conductive member 1102 (such as the drain). The position of the contact hole CT5 can correspond to the contact hole CT3, and the contact hole CT5 can penetrate through the second insulating layer 116 and the first insulating layer 112, so as to expose a portion of the upper surface of the conductive member 1103. For example, the contact hole CT4 may be located in the contact hole CT2, and the contact hole CT5 may be located in the contact hole CT3, but it is not limited thereto.

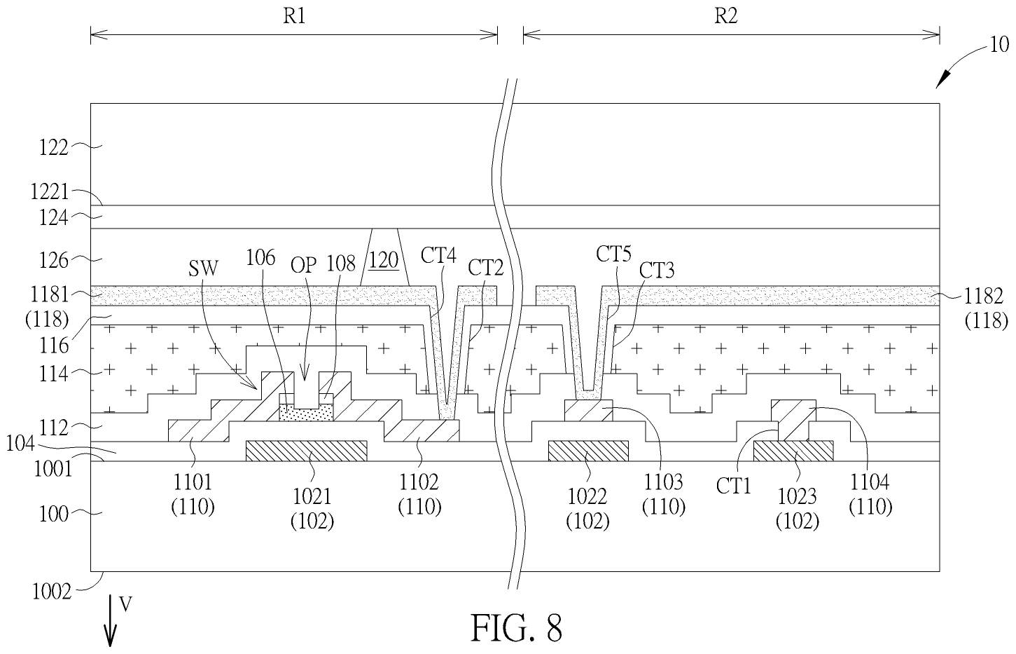

Next, as shown in FIG. 8, a transparent conductive layer 118 is formed on the second insulating layer 116. For example, the transparent conductive layer 118 may include a pixel electrode 1181 and a conductive wire 1182, but it is not limited thereto. A portion of the pixel electrode 1181 may be filled in the contact hole CT4 and in contact with a portion of the upper surface of the conductive member 1102 (such as the drain) to achieve the electrical connection. A portion of the conductive wire 1182 may be filled in the contact hole CT5 and in contact with the upper surface of a portion of the conductive member 1103 to achieve the electrical connection. For example, the conductive wire 1182 may extend to the bonding area (not shown) of the peripheral region R2 and electrically connect the bonding pad in the bonding area, but it is not limited thereto. In addition, the pixel electrode 1181 may be electrically isolated from the conductive wire 1182, or the pixel electrode 1181 may not be in contact with the conductive wire 1182. In the present embodiment, the transparent conductive layer 118 may be, for example, a patterned transparent conductive layer formed through the photolithography and etching process, but it is not limited thereto. The material of the transparent conductive layer 118 may include indium tin oxide (ITO), indium zinc oxide (IZO), indium gallium zinc oxide (IGZO), indium tin zinc oxide (ITZO), antimony tin oxide (ATO), antimony zinc oxide (AZO), other suitable transparent conductive materials, or a combination thereof, but it is not limited thereto.

Furthermore, as shown in FIG. 8, a spacer 120 is formed on the transparent conductive layer 118 (such as the pixel electrode 1181). The material of the spacer 120 may include a photoresist material, but it is not limited thereto.

Next, as shown in FIG. 8, the first substrate 100 is assembled with the second substrate 122, so that the spacer 120 can be disposed between the first substrate 100 and the second substrate 122. For example, the two ends of the spacer 120 may be respectively in contact with the film layer on the first surface 1001 of the first substrate 100 (such as the pixel electrode 1181 of the transparent conductive layer 118) and the film layer on a surface 1221 of the second substrate 122 (such as a common electrode 124), but it is not limited thereto. In FIG. 8, the common electrode 124 may be formed on the surface 1221 of the second substrate 122. The material of the common electrode 124 may include a transparent conductive material, but it is not limited thereto. In some embodiments, other elements or film layers, such as black matrix, spacers (not shown), may be selectively formed on the surface 1221 of the second substrate 122, but it is not limited thereto.

Next, as shown in FIG. 8, a cholesteric liquid crystal layer 126 is formed between the first substrate 100 and the second substrate 122 so as to form a cholesteric liquid crystal display 10, but it is not limited thereto. For example, the cholesteric liquid crystal layer 126 may be disposed on the first substrate 100 through inkjet printing, injection, or thermal dropping, and then the second substrate 122 may be disposed and attached to the first substrate 100, but it is not limited thereto. In some embodiments (such as FIG. 8), the black light absorption layer 114 may be disposed between the switch SW and the cholesteric liquid crystal layer 126, and the second insulating layer 116 may be disposed between the black light absorption layer 114 and the cholesteric liquid crystal layer 126, but it is not limited thereto. In other words, the black light absorption layer 114 of the present embodiment is formed on a thin film transistor substrate that includes the switch SW. When the cholesteric liquid crystal display 10 is in a dark state, a portion of the lights will penetrate the cholesteric liquid crystal layer 126 or be scattered within the display. However, these lights can be absorbed by the black light absorption layer 114 to prevent the lights from being reflected by the metal elements inside the display. Therefore, the contrast of reflected image of the cholesteric liquid crystal display 10 can be increased, thereby improving the display quality of the cholesteric liquid crystal display 10.

The cholesteric liquid crystal display of the present invention and the fabricating method thereof are not limited to the above embodiments. The following continues to disclose other embodiments of the present invention. In order to simplify the description and highlight the differences between the embodiments, the same reference numerals are used to designate the same elements, and the details of the same elements will not be repeated.

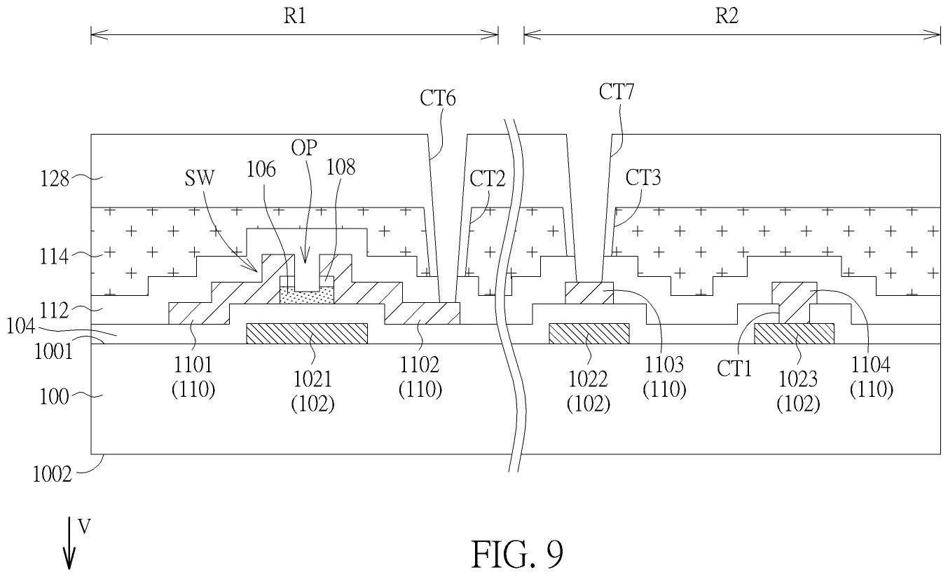

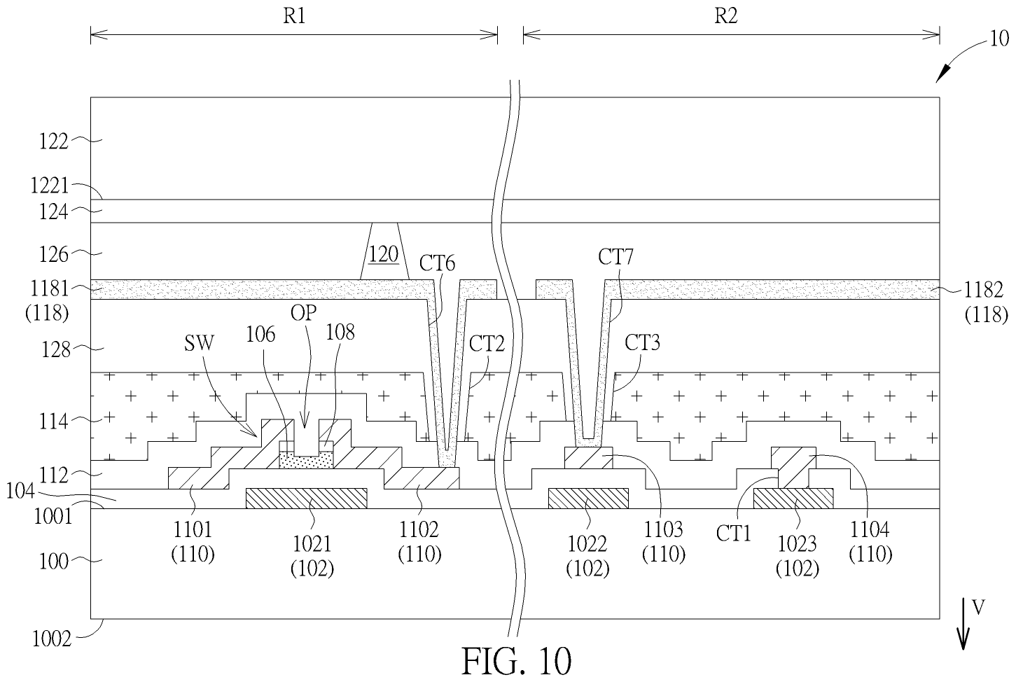

Referring to FIG. 9 to FIG. 10, those are schematic diagrams of a method for fabricating a cholesteric liquid crystal display according to a second embodiment of the present invention. In the method for fabricating the cholesteric liquid crystal display 10 of this embodiment, the steps from providing the first substrate 100 to forming the black light absorption layer 114 may be the same as those in the first embodiment (as shown in FIG. 1 to FIG. 6), and will not be repeated here. As shown in FIG. 9, this embodiment differs from the first embodiment in that, after the black light absorption layer 114 is formed in this embodiment, a planarization layer 128 is formed on the black light absorption layer 114, and a portion of the planarization layer 128 may be filled in the contact hole CT2 and the contact hole CT3. For example, the thickness of the planarization layer 128 may range from about 1.5 μm to about 2.0 μm, but it is not limited thereto. Therefore, in the present embodiment, the thickness of the planarization layer 128 may be greater than the thickness of the black light absorption layer 114 (about 1 μm), but it is not limited thereto. The material of the planarization layer 128 may include an organic insulating material, but it is not limited thereto. Moreover, the planarization layer 128 of this embodiment may provide a flat upper surface, but it is not limited thereto.

Next, as shown in FIG. 9, a contact hole CT6 and a contact hole CT7 can be formed through the photolithography and etching process. The position of the contact hole CT6 can correspond to the contact hole CT2, and the contact hole CT6 can penetrate through the planarization layer 128 and the first insulating layer 112 so as to expose a portion of the upper surface of the conductive member 1102 (such as the drain). The position of the contact hole CT7 can correspond to the contact hole CT3, and the contact hole CT7 can penetrate through the second insulating layer 116 and the planarization layer 128 so as to expose a portion of the upper surface of the conductive member 1103.

Next, as shown in FIG. 10, a transparent conductive layer 118 is formed on the planarization layer 128. A portion of the pixel electrode 1181 in the transparent conductive layer 118 may be filled in the contact hole CT6 and in contact with a portion of the upper surface of the conductive member 1102 (such as the drain) to achieve the electrical connection. A portion of the conductive wire 1182 in the transparent conductive layer 118 may be filled in the contact hole CT7 and in contact with a portion of the upper surface of the conductive member 1103 to achieve the electrical connection. In addition, the steps of forming the spacer 120 on the transparent conductive layer 118 (such as the pixel electrode 1181), assembling the first substrate 100 with the second substrate 122, and forming the cholesteric liquid crystal layer 126 between the first substrate 100 and the second substrate 122 may be the same as those in the first embodiment (as shown in FIG. 8), and will not be repeated here. Therefore, the present embodiment (see FIG. 10) differs from the first embodiment in that, the second insulating layer 116 of the first embodiment is replaced with the planarization layer 128 in this embodiment, wherein the planarization layer 128 may be disposed between the black light absorption layer 114 and the cholesteric liquid crystal layer 126.

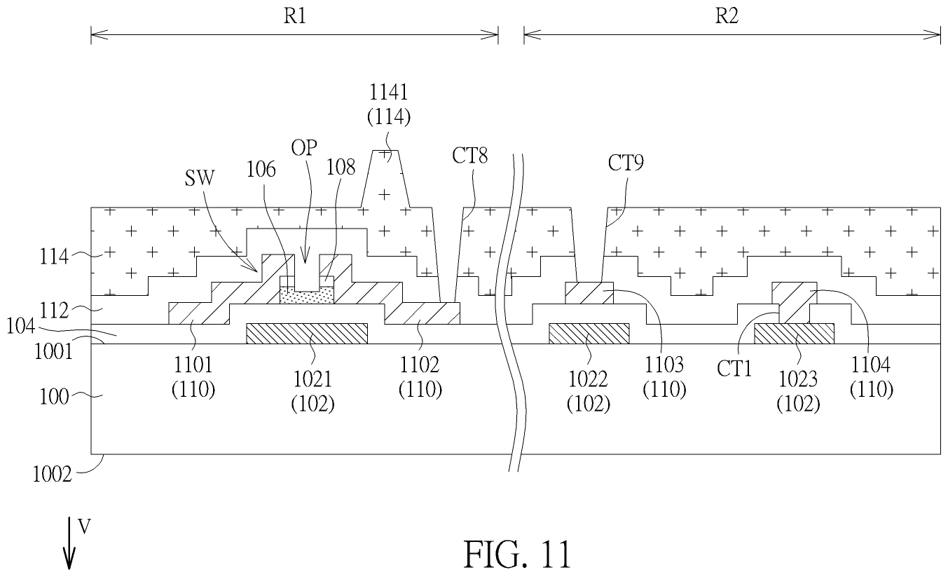

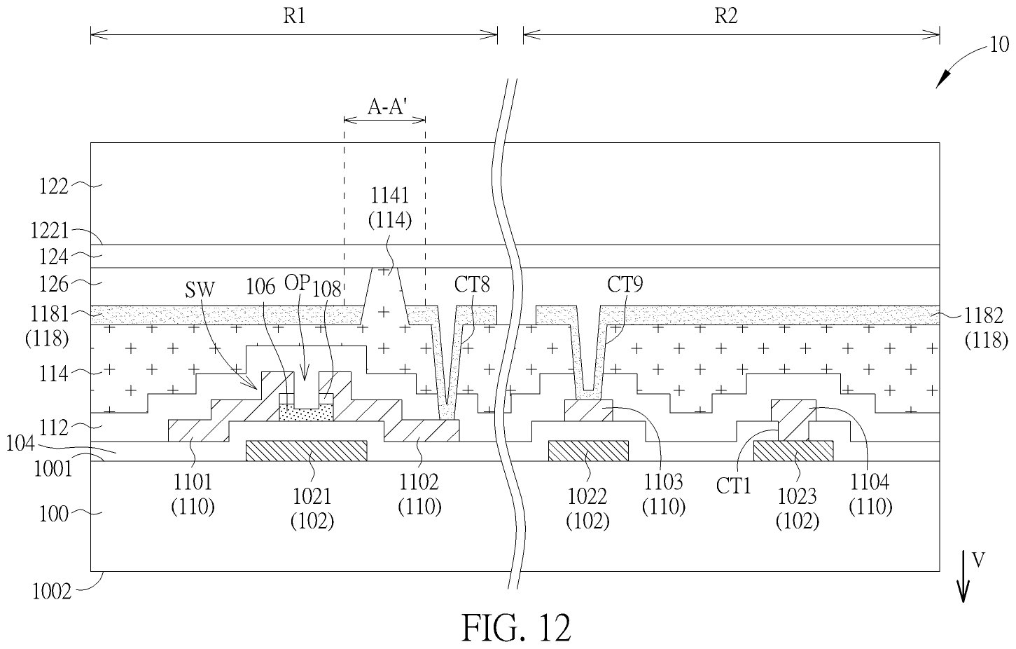

Referring to FIG. 11 to FIG. 12, those are schematic diagrams of a method for fabricating a cholesteric liquid crystal display according to a third embodiment of the present invention. In the method for fabricating the cholesteric liquid crystal display 10 of this embodiment, the steps from providing the first substrate 100 to forming the first insulating layer 112 may be the same as those in the first embodiment (as shown in FIG. 1 to FIG. 5), and will not be repeated here. After the first insulating layer 112 is formed, the black light absorption layer 114 is formed on the first insulating layer 112 as shown in FIG. 11. The difference between this embodiment and the first embodiment (see FIG. 6) is that the thickness of the black light absorption layer 114 of this embodiment may be greater than the thickness of the black light absorption layer 114 of the first embodiment. Moreover, the black light absorption layer 114 of this embodiment may also include a spacer 1141. The spacer 1141 may be a portion of the black light absorption layer 114, and the spacer 1141 may be formed together with the black light absorption layer 114, but it is not limited thereto. The thickness of the black light absorption layer 114 of this embodiment may range from about 2.2 μm to about 6.5 μm (which can be achieved or accompanied by half-tone mask design), and the thickness may include the height of the spacer 1141, but it is not limited thereto. In addition, the black light absorption layer 114 of this embodiment may provide a flat upper surface. Furthermore, the black light absorption layer 114 of this embodiment has the advantage of saving a mask used for forming the spacer and in turn reduces the production cost and enhances the product competitiveness, but it is not limited thereto.

As shown in FIG. 11, a contact hole CT8 and a contact hole CT9 may be formed in the black light absorption layer 114 through the photolithography and etching process. The contact hole CT8 can be disposed on the conductive member 1102 (such as the drain), and the contact hole CT8 can penetrate through the black light absorption layer 114 and the first insulating layer 112 so as to expose a portion of the upper surface of the conductive member 1102. The contact hole CT9 can be disposed on the conductive member 1103, and the contact hole CT9 can penetrate through the black light absorption layer 114 and the first insulating layer 112 so as to expose a portion of the upper surface of the conductive member 1103.

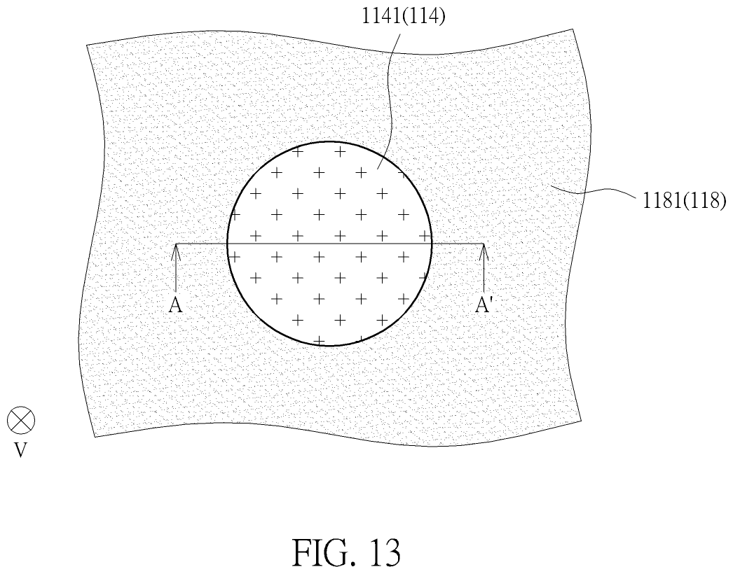

Next, as shown in FIG. 12, the transparent conductive layer 118 is formed on the black light absorption layer 114. A portion of the pixel electrode 1181 of the transparent conductive layer 118 may be filled in the contact hole CT8 and in contact with a portion of the upper surface of the conductive member 1102 (such as the drain) to achieve the electrical connection. A portion of the conductive wire 1182 of the transparent conductive layer 118 may be filled in the contact hole CT9 and in contact with a portion of the upper surface of the conductive member 1103 to achieve the electrical connection. Referring to FIG. 13, which is a schematic top view of a spacer and a surrounding transparent conductive layer according to the third embodiment of the present invention. The cross-sectional structure taken along a line A-A′ in FIG. 12 may correspond to the structure taken along the line A-A′ in FIG. 13. From the top view direction V, a transparent conductive layer 118 (such as a pixel electrode 1181) may surround the spacer 1141 as shown in FIG. 13, so that the pixel electrodes 1181 on the left and right sides of the spacer 1141 in FIG. 12 may maintain the electrical connection, but it is not limited thereto.

In addition, the steps of assembling the first substrate 100 with the second substrate 122 and forming the cholesteric liquid crystal layer 126 between the first substrate 100 and the second substrate 122 may be the same as those in the first embodiment (such as FIG. 8), and will not be repeated here. Therefore, the present embodiment (as shown in FIG. 12) differs from the first embodiment in that, the cholesteric liquid crystal display 10 of this embodiment does not include the second insulating layer 116 of the first embodiment. Furthermore, the black light absorption layer 114 of this embodiment may include the spacer 1141, and the spacer 1141 may be disposed between the first substrate 100 and the second substrate 122.

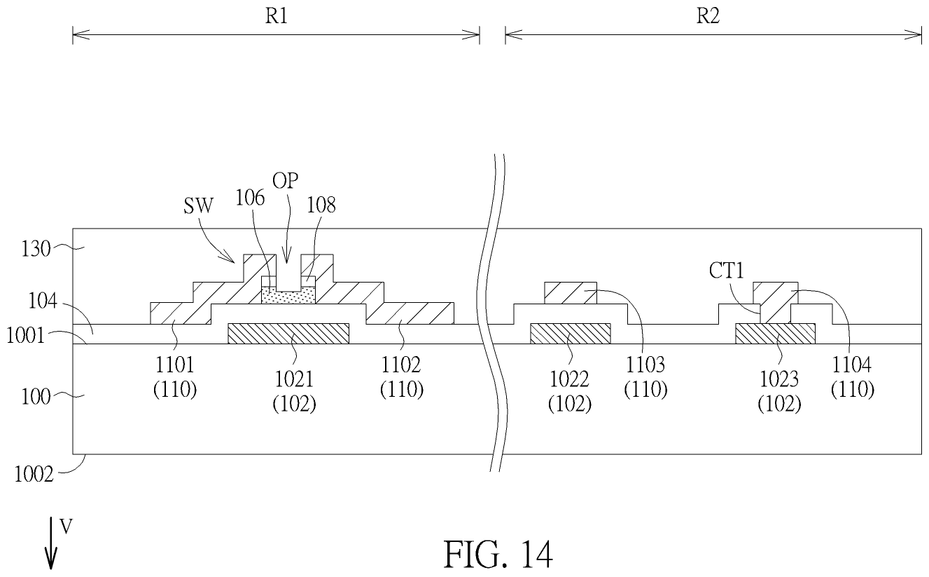

Referring to FIG. 14 to FIG. 17, those are schematic diagrams of a method for fabricating a cholesteric liquid crystal display according to a fourth embodiment of the present invention. In the method for fabricating the cholesteric liquid crystal display 10 of this embodiment, the steps from providing the first substrate 100 to forming the second conductive layer 110 may be the same as those in the first embodiment (as shown in FIG. 1 to FIG. 4), and will not be repeated here. As shown in FIG. 14, this embodiment differs from the first embodiment in that, a planarization layer 130 is formed on the switch SW after the second conductive layer 110 is formed in this embodiment. The planarization layer 130 may cover the switch SW, the conductive member 1103, the conductive member 1104, and a portion of the gate insulating layer 104. For example, the thickness of the planarization layer 130 may be about 1.2 μm, but it is not limited thereto. The material of the planarization layer 130 may include an organic insulating material, but it is not limited thereto. In addition, the planarization layer 130 of this embodiment may provide a flat upper surface, but it is not limited thereto.

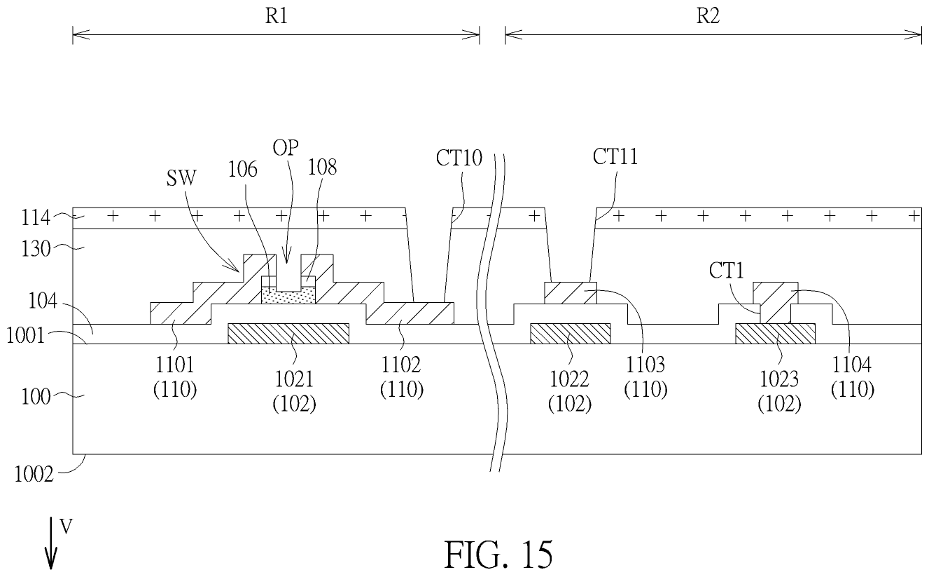

Next, as shown in FIG. 15, the black light absorption layer 114 is formed on the planarization layer 130 so that the planarization layer 130 may be disposed between the switch SW and the black light absorption layer 114. The thickness of the black light absorption layer 114 in this embodiment may be about 1 μm, but it is not limited thereto. Therefore, in this embodiment, the thickness of the planarization layer 130 may be greater than the thickness of the black light absorption layer 114. Next, as shown in FIG. 15, a contact hole CT10 and a contact hole CT11 may be formed in the black light absorption layer 114 through the photolithography and etching process. The contact hole CT10 can be disposed on the conductive member 1102 (such as the drain), and the contact hole CT10 can penetrate through the black light absorption layer 114 and the planarization layer 130 so as to expose a portion of the upper surface of the conductive member 1102. The contact hole CT11 can be disposed on the conductive member 1103, and the contact hole CT11 may penetrate through the black light absorption layer 114 and the planarization layer 130 so as to expose a portion of the upper surface of the conductive member 1103.

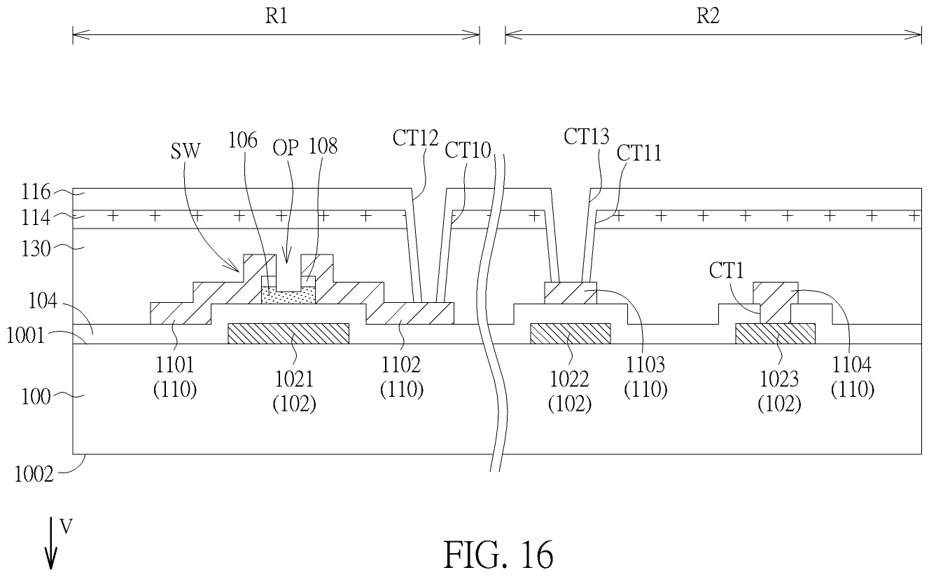

Next, as shown in FIG. 16, the second insulating layer 116 is formed on the black light absorption layer 114, and a portion of the second insulating layer 116 may be filled in the contact hole CT10 and the contact hole CT11. For example, the thickness of the second insulating layer 116 may be about 0.2 μm, but it is not limited thereto. Therefore, in this embodiment, the thickness of the second insulating layer 116 may be less than the thickness of the black light absorption layer 114, but it is not limited thereto. Next, as shown in FIG. 16, a contact hole CT12 and a contact hole CT13 may be formed through the photolithography and etching process. The position of the contact hole CT12 can correspond to the contact hole CT10, and the contact hole CT12 can penetrate through the second insulating layer 116 so as to expose the upper surface of a portion of the conductive member 1102 (such as the drain). The position of the contact hole CT13 can correspond to the contact hole CT11, and the contact hole CT13 can penetrate through the second insulating layer 116 so as to expose a portion of the upper surface of the conductive member 1103.

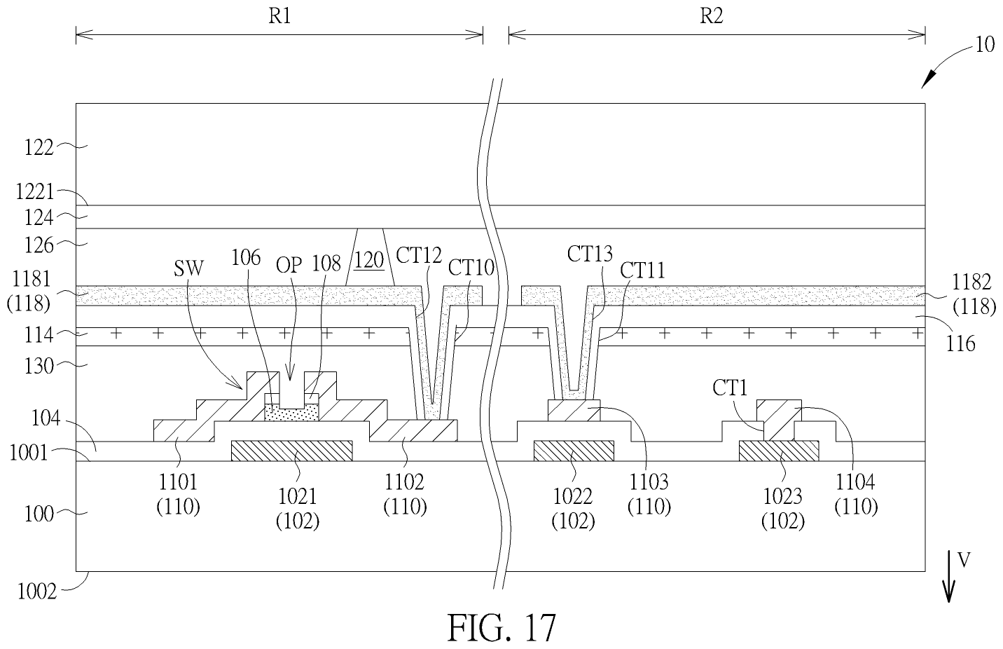

Next, as shown in FIG. 17, the transparent conductive layer 118 is formed on the second insulating layer 116. A portion of the pixel electrode 1181 of the transparent conductive layer 118 may be filled in the contact hole CT12 and in contact with a portion of the upper surface of the conductive member 1102 (such as the drain) to achieve the electrical connection. A portion of the conductive wire 1182 of the transparent conductive layer 118 may be filled in the contact hole CT13 and in contact with a portion of the upper surface of the conductive member 1103 to achieve the electrical connection. Moreover, the steps of forming the spacer 120 on the transparent conductive layer 118 (such as the pixel electrode 1181), assembling the first substrate 100 with the second substrate 122, and forming the cholesteric liquid crystal layer 126 between the first substrate 100 and the second substrate 122 may be the same as those in the first embodiment (as shown in FIG. 8), and will not be repeated here. Therefore, the present embodiment (see FIG. 17) differs from the first embodiment in that, the first insulating layer 112 of the first embodiment is replaced with the planarization layer 130 in this embodiment, and the planarization layer 130 may be disposed between the switch SW and the black light absorption layers 114.

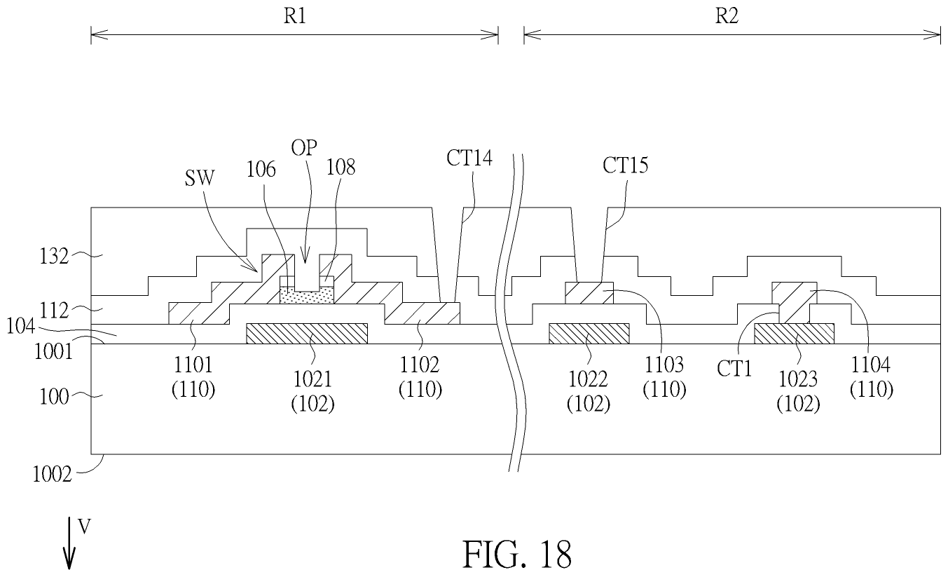

Referring to FIG. 18 to FIG. 20, those are schematic diagrams of a method for fabricating a cholesteric liquid crystal display according to a fifth embodiment of the present invention. In the method for fabricating the cholesteric liquid crystal display 10 of this embodiment, the steps from providing the first substrate 100 to forming the first insulating layer 112 may be the same as those in the first embodiment (as shown in FIG. 1 to FIG. 5), and will not be repeated here. As shown in FIG. 18, this embodiment differs from the first embodiment in that, after the first insulating layer 112 is formed in this embodiment, a planarization layer 132 is formed on the first insulating layer 112, and the planarization layer 132 may provide a flat upper surface. In other embodiments, the second insulating layer 116 in the first embodiment may be formed on the first insulating layer 112, and the second insulating layer 116 may be conformally formed on the first insulating layer 112.

Next, as shown in FIG. 18, a contact hole CT14 and a contact hole CT15 may be formed in the planarization layer 132 through the photolithography and etching process. The contact hole CT14 can be disposed on the conductive member 1102 (such as the drain), and the contact hole CT14 can penetrate through the planarization layer 132 and the first insulating layer 112 so as to expose a portion of the upper surface of the conductive member 1102 (such as the drain). The contact hole CT15 can be disposed on the conductive member 1103, and the contact hole CT15 can penetrate through the planarization layer 132 and the first insulating layer 112 so as to expose a portion of the upper surface of the conductive member 1103.

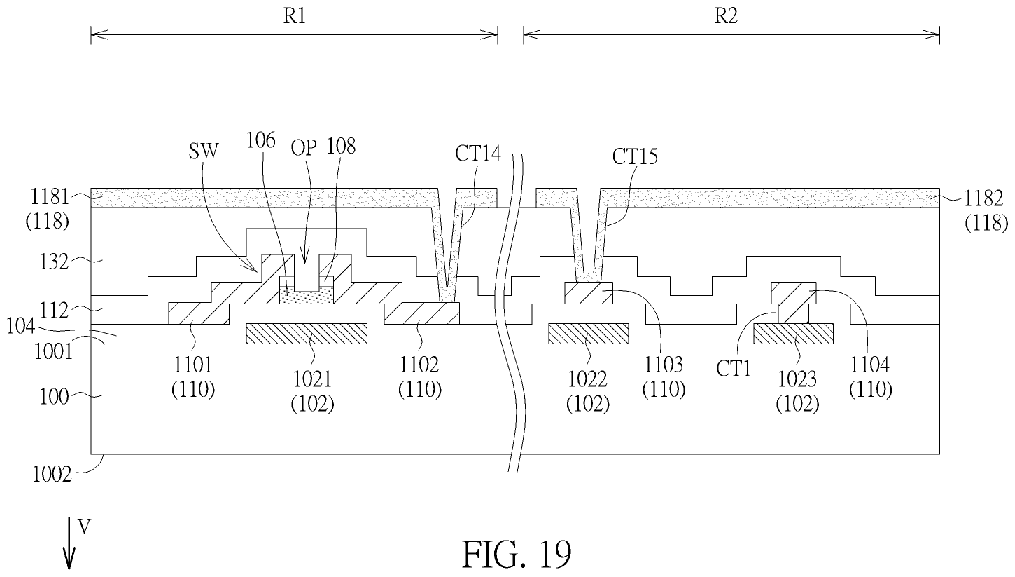

Next, as shown in FIG. 19, the transparent conductive layer 118 is formed on the planarization layer 132. A portion of the pixel electrode 1181 of the transparent conductive layer 118 may be filled in the contact hole CT14 and in contact with a portion of the upper surface of the conductive member 1102 (such as the drain) to achieve the electrical connection. A portion of the conductive wire 1182 of the transparent conductive layer 118 may be filled in the contact hole CT15 and in contact with a portion of the upper surface of the conductive member 1103 to achieve the electrical connection.

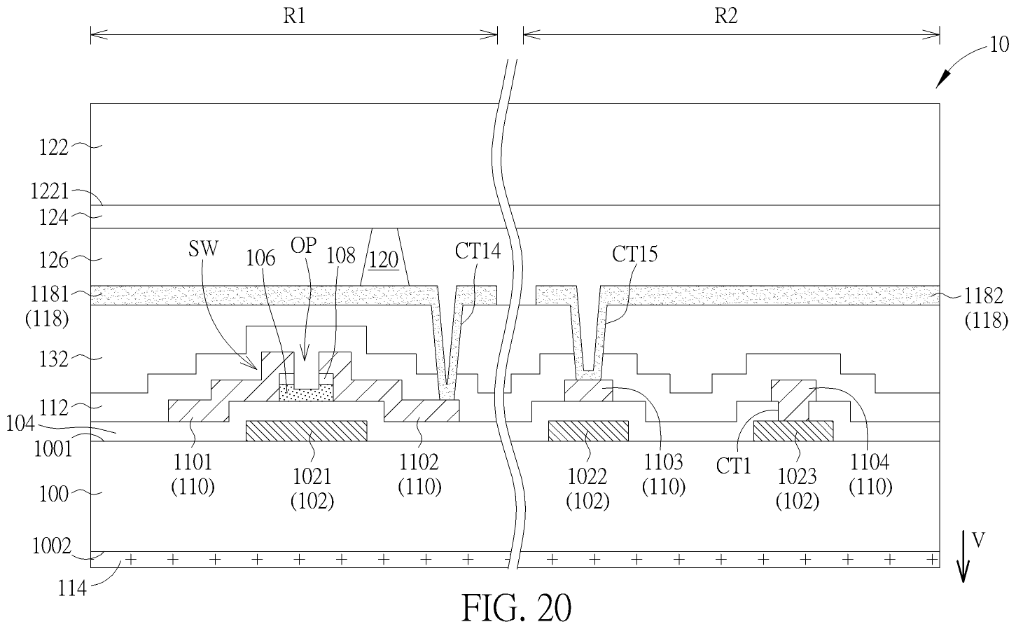

Next, as shown in FIG. 20, the spacer 120 may be formed on the transparent conductive layer 118 (such as the pixel electrode 1181). The first substrate 100 is assembled with the second substrate 122, and the cholesteric liquid crystal layer 126 is formed between the first substrate 100 and second substrates 122. The technical features of the above steps may be the same as those in the first embodiment (as shown in FIG. 8), and will not be repeated here. Furthermore, after assembling the first substrate 100 with the second substrate 122 and forming the cholesteric liquid crystal layer 126 between the first substrate 100 and the second substrate 122, the cholesteric liquid crystal display 10 may be reversed (or turned over) and the black light absorption layer 114 can be formed on the second surface 1002 of the first substrate 100. In some embodiments, for example, the black light absorption layer 114 may be formed on the second surface 1002 through evaporation. In other embodiments, for example, the black light absorption layer 114 may be attached (or adhered) to the second surface 1002. Therefore, the present embodiment (as shown in FIG. 20) differs from the first embodiment in that, the black light absorption layer 114 of this embodiment is disposed on the second surface 1002 of the first substrate 100, and the first substrate 100 needs to be reversed during the fabrication and a black matrix (BM) material is coated on the back surface (such as the second surface 1002), but it is not limited thereto.

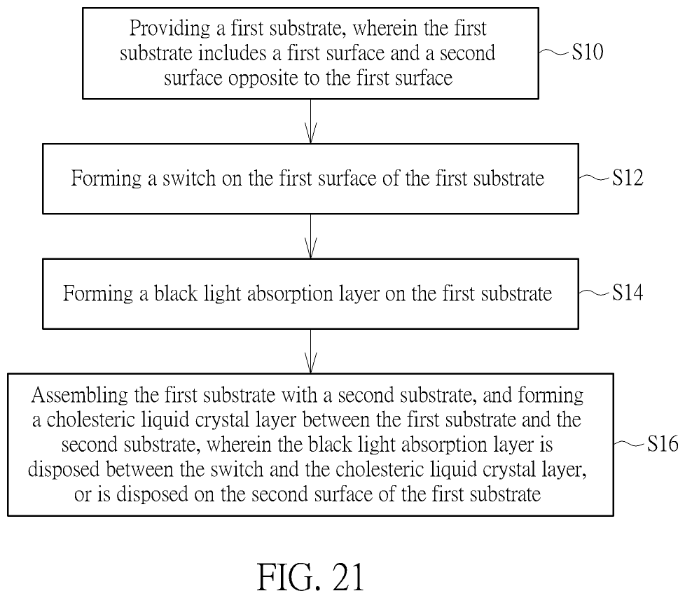

In conclusion and please refer to FIG. 21, wherein FIG. 21 is a flowchart of steps of a method for fabricating a cholesteric liquid crystal display of the present invention. The method for fabricating the cholesteric liquid crystal display 10 of the present invention mainly includes the steps shown in FIG. 21:

Step S10: providing a first substrate, wherein the first substrate includes a first surface and a second surface opposite to the first surface;

Step S12: forming a switch on the first surface of the first substrate;

Step S14: forming a black light absorption layer on the first substrate; and

Step S16: assembling the first substrate with a second substrate, and forming a cholesteric liquid crystal layer between the first substrate and the second substrate, wherein the black light absorption layer is disposed between the switch and the cholesteric liquid crystal layer, or is disposed on the second surface of the first substrate.

It should be understood that the steps shown in the method for fabricating a cholesteric liquid crystal display in the above embodiments are not exhaustive, and other steps may be performed before, after, or between any of the disclosed steps. Besides, certain steps may be performed in a different order.

In addition, as shown in FIG. 8, FIG. 10, FIG. 12, FIG. 17 and/or FIG. 20, the cholesteric liquid crystal display 10 of the present invention may mainly include the first substrate 100, the second substrate 122, the cholesteric liquid crystal layer 126, the switch SW, and the black light absorption layer 114. The first substrate 100 may include the first surface 1001 and the second surface 1002 opposite to the first surface 1001. The switch SW may be disposed on the first surface 1001 of the first substrate 100. The second substrate 122 may be disposed opposite to the first substrate 100. The cholesteric liquid crystal layer 126 may be disposed between the first substrate 100 and the second substrate 122. The black light absorption layer 114 may be disposed between the switch SW and the cholesteric liquid crystal layer 126, or may be disposed on the second surface 1002 of the first substrate 100.

In the present invention, the black light absorption layer is formed on the thin film transistor substrate that includes a switch. When the cholesteric liquid crystal display is in the dark state, a portion of the lights will penetrate the cholesteric liquid crystal layer or be scattered within the display. However, these lights may be absorbed by the black light absorption layer to prevent the lights from being reflected by the metal elements and the interface of each layer in the display. Therefore, the contrast of image of the cholesteric liquid crystal display may be increased, thereby improving the display quality of the cholesteric liquid crystal display.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cholesteric liquid crystal display device, comprising:
a first substrate including a first surface and a second surface opposite to the first surface;
a switch disposed on the first surface of the first substrate;
a second substrate disposed opposite to the first substrate;
a cholesteric liquid crystal layer disposed between the first substrate and the second substrate; and
a black light absorption layer disposed between the switch and the cholesteric liquid crystal layer, or disposed on the second surface of the first substrate.

2. The cholesteric liquid crystal display device according to claim 1, wherein the black light absorption layer has a thickness ranging from 0.5 μm to 3 μm.

3. The cholesteric liquid crystal display device according to claim 1, wherein an optical density of the black light absorption layer is in a range from 2 to 6.

4. The cholesteric liquid crystal display device according to claim 1, wherein when the black light absorption layer is disposed between the switch and the cholesteric liquid crystal layer, the cholesteric liquid crystal display device further comprises a first insulating layer disposed between the switch and the black light absorption layer.

5. The cholesteric liquid crystal display device according to claim 4, further comprising a second insulating layer disposed between the black light absorption layer and the cholesteric liquid crystal layer, wherein a thickness of the second insulating layer is less than a thickness of the black light absorption layer.

6. The cholesteric liquid crystal display device according to claim 4, further comprising a planarization layer disposed between the black light absorption layer and the cholesteric liquid crystal layer, wherein a thickness of the planarization layer is greater than a thickness of the black light absorption layer.

7. The cholesteric liquid crystal display device according to claim 4, wherein the black light absorption layer comprises a spacer disposed between the first substrate and the second substrate.

8. The cholesteric liquid crystal display device according to claim 1, wherein when the black light absorption layer is disposed between the switch and the cholesteric liquid crystal layer, the cholesteric liquid crystal display device further comprises a planarization layer disposed between the switch and the black light absorption layer.

9. The cholesteric liquid crystal display device according to claim 8, wherein a thickness of the planarization layer is greater than a thickness of the black light absorption layer.

10. A method for fabricating a cholesteric liquid crystal display device, comprising:
providing a first substrate, wherein the first substrate includes a first surface and a second surface opposite to the first surface;
forming a switch on the first surface of the first substrate;
forming a black light absorption layer on the first substrate; and
assembling the first substrate with a second substrate, and forming a cholesteric liquid crystal layer between the first substrate and the second substrate,
wherein the black light absorption layer is disposed between the switch and the cholesteric liquid crystal layer, or is disposed on the second surface of the first substrate.

11. The method for fabricating the cholesteric liquid crystal display device according to claim 10, wherein the black light absorption layer has a thickness ranging from 0.5 μm to 3 μm.

12. The method for fabricating the cholesteric liquid crystal display device according to claim 10, wherein an optical density of the black light absorption layer is in a range from 2 to 6.

13. The method for fabricating the cholesteric liquid crystal display device according to claim 10, wherein when the black light absorption layer is disposed between the switch and the cholesteric liquid crystal layer, the method further comprises:
forming a first insulating layer on the switch; and
forming the black light absorption layer on the first insulating layer, wherein the first insulating layer is disposed between the switch and the black light absorption layer.

14. The method for fabricating the cholesteric liquid crystal display device according to claim 13, further comprising forming a second insulating layer on the black light absorption layer, wherein the second insulating layer is disposed between the black light absorption layer and the cholesteric liquid crystal layer, and a thickness of the second insulating layer is less than a thickness of the black light absorption layer.

15. The method for fabricating the cholesteric liquid crystal display device according to claim 13, further comprising forming a planarization layer on the black light absorption layer, wherein the planarization layer is disposed between the black light absorption layer and the cholesteric liquid crystal layer, and a thickness of the planarization layer is greater than a thickness of the black light absorption layer.

16. The method for fabricating the cholesteric liquid crystal display device according to claim 13, wherein the black light absorption layer comprises a spacer disposed between the first substrate and the second substrate.

17. The method for fabricating the cholesteric liquid crystal display device according to claim 10, wherein when the black light absorption layer is disposed between the switch and the cholesteric liquid crystal layer, the method further comprises:
forming a planarization layer on the switch; and
forming the black light absorption layer on the planarization layer, wherein the planarization layer is disposed between the switch and the black light absorption layer.

18. The method for fabricating the cholesteric liquid crystal display device according to claim 17, wherein a thickness of the planarization layer is greater than a thickness of the black light absorption layer.

19. The method for fabricating the cholesteric liquid crystal display device according to claim 10, wherein the black light absorption layer is formed on the second surface of the first substrate after assembling the first substrate with the second substrate and forming the cholesteric liquid crystal layer between the first substrate and the second substrate.
